(19) United States
(12) Patent Application Publication
(10) Pub. No.: US 2014/0365307 A1
(43) Pub. Date: Dec. 11, 2014

(54) TRANSMITTING LISTINGS BASED ON DETECTED LOCATION

(71) Applicant: Dennis Cheung, Sunnyvale, CA (US)

(72) Inventor: Dennis Cheung, Sunnyvale, CA (US)

(73) Assignee: EBAY INC., SAN JOSE, CA (US)

(21) Appl. No.: 14/107,173

(22) Filed: Dec. 16, 2013

Related U.S. Application Data
(60) Provisional application No. 61/832,577, filed on Jun. 7, 2013.

(51) Int. Cl. G06Q 30/02

(52) U.S. Cl. CPC G06Q 30/0261; G06Q 30/0267
USPC 705/14.58

(57) ABSTRACT

Systems and methods for facilitating location-aware listing publication are discussed. A listing can include an item location corresponding to an item described in the listing. The listing may be received on a central server from a device operated by a first user. A geofence can be generated around the item location corresponding to the item described in the listing. The geofence surrounding the item location can be monitored for a second user. A second user can be detected within the geographical area enclosed by the geofence. In response to detecting the second user, a determination can be made as to whether the second user has indicated an interest in the item described in the listing. In response to the determination, the listing can be transmitted to a second device operated by the second user to notify the second user of the published listing.

### RELATED APPLICATION

This application claims the priority benefit of U.S. Provisional Patent Application No. 61/832,577, filed Jun. 7, 2013, which is incorporated herein by reference in its entirety.

### TECHNICAL FIELD

The subject matter disclosed herein generally relates to the processing of data. Specifically, the present disclosure addresses systems and methods to transmit listings based on a detected location.

### BACKGROUND

A publication server may publish a listing that describes an item available for sale. The listing may be hosted on a web page and viewed by users browsing the web page via a device of the user.

### BRIEF DESCRIPTION OF THE DRAWINGS

Some embodiments are illustrated by way of example and not limitation in the figures of the accompanying drawings.

FIG. 1 is a network diagram illustrating a network environment suitable to transmit a listing based on a detected location, according to some example embodiments.

FIG. 2 is a block diagram illustrating components of a location machine, according to some example embodiments.

FIG. 3-4 are example user interfaces of a map depicting an item location and a geofence surrounding the item location, according to some example embodiments.

FIG. 5 is an example user interface depicting an exchange finder, according to some example embodiments.

FIG. 6 is an example user interface depicting a set of locations, according to some example embodiments.

FIG. 7 is an example user interface depicting the set of locations on a map, according to some example embodiments.

FIG. 8 is a flowchart illustrating a method of transmitting a listing, according to some example embodiments.

FIG. 9 is a flowchart illustrating a method of transmitting an exchange location, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to transmitting a listing based on a detected location. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In an example, an online system can be provided to assist a seller in selling items that are difficult to ship or otherwise would benefit from local pick-up at an exchange location. The exchange location may be presented to the buyer and used to facilitate a transaction between the seller and the buyer. In other examples, the online system can also be configured to provide localized publication services that may not be directly related to selling or buying goods or services. In the local seller example, the online system can provide a mechanism for sellers to notify potential buyers that happen to be within a pre-defined distance from a location of an item or service available for sale by the seller. The exchange location may be used to facilitate a transaction of the item or service between the buyer and the seller. This may allow the location of the item or service to be kept private from the buyer. The location of the item or service may be sensitive information that the seller would like to keep private.

The online system may receive a listing that describes an item available for sale. The online system may also receive a location of the item described by the listing. The listing and the location of the item may be received from a device of a user. In response, the online system may generate a geofence around the location of the item and monitor the geofence for potential buyers. Once a potential buyer is detected as being within the generated geofence, the system may transmit the listing that describes the item to a device of the potential buyer.

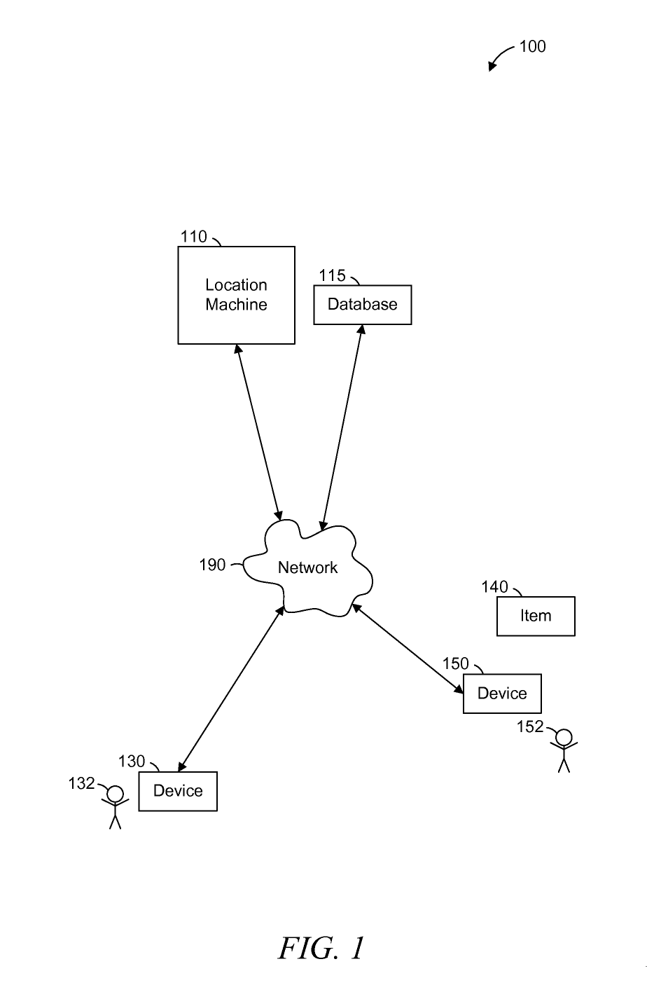

FIG. 1 is a network diagram illustrating a network environment 100 suitable to transmit a listing based on a detected location, according to some example embodiments. The network environment 100 includes a location machine 110, a database 115, and devices 130 and 150, all communicatively coupled to each other via a network 190.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

In various example embodiments, the location machine 110 may detect that the user 152 is within a predetermined distance from a location of an item 140 (e.g., an item or service available for sale). For instance, the user 152 may be detected as being within a geofence surrounding the location of the item 140. The geofence may be generated and monitored by the location machine 110. Upon detecting the user 152 as being within the geofence, an item listing that describes the item 140 may then be transmitted to a device 150 belonging to the user 152.

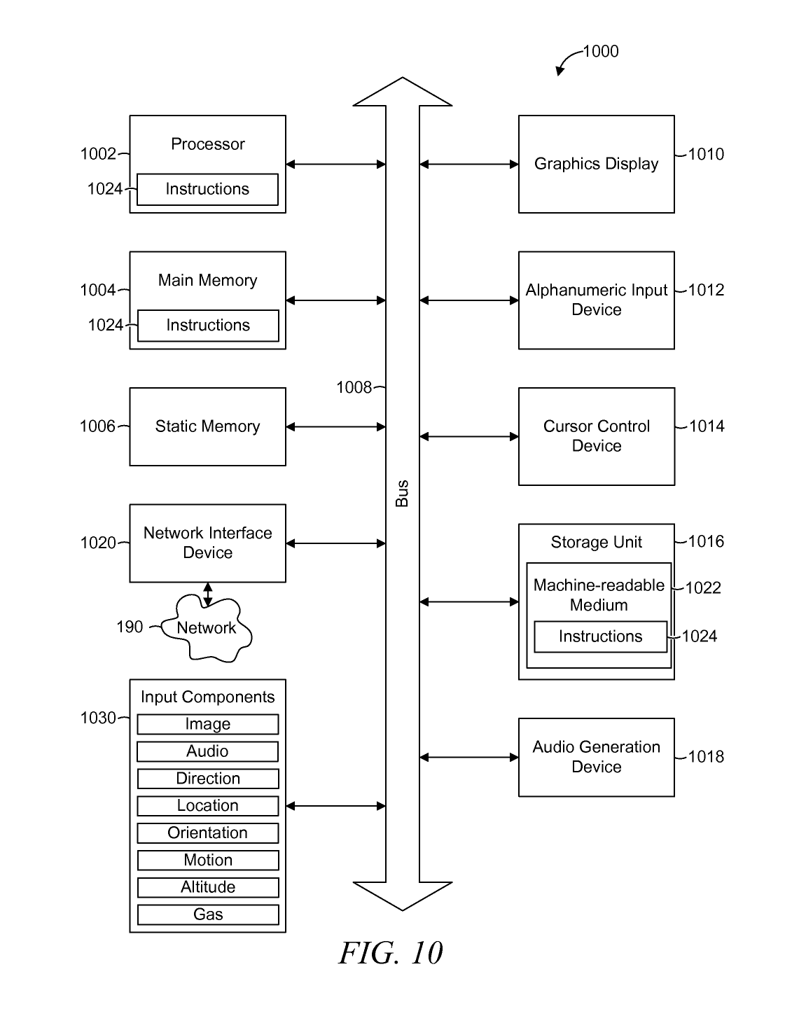

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the location machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” shall be taken to include any medium that is capable of storing, encoding, or carrying instructions for execution by a machine, and includes digital or analog communication signals or other intangible media to facilitate communication of such software.

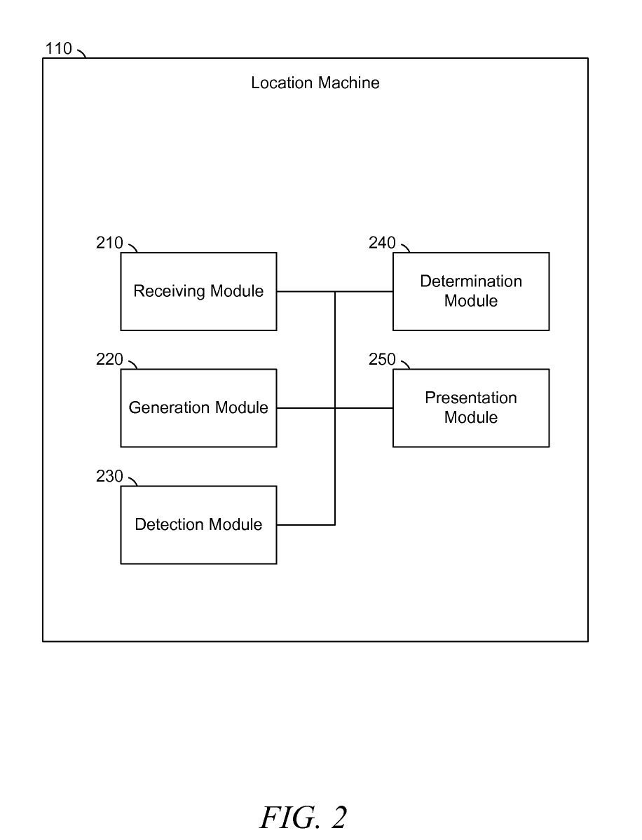

FIG. 2 is a block diagram illustrating components of the location machine 110, according to some example embodiments. The location machine 110 is shown as including a receiving module 210, a generation module 220, a detection module 230, a determination module 240, and a presentation module 250, all configured to communicate with each other (e.g., via a bus, shared memory, or a switch).

In various example embodiments, the receiving module 210 is configured to receive a listing that is to be published by the presentation module 250. The listing may describe an item and may further include an item location corresponding to the item described in the listing. For instance, the listing may include a picture of the item, a description of the item, or any suitable combination thereof. Moreover, the listing may be viewed as a web page. In various example embodiments, the receiving module 210 may receive the listing from a device 130 operated by a user 132. The user 132 may be a seller of the item described in the listing. The user may provide the picture of the item, the description of the item, or any suitable combination thereof to the receiving module 210 using the device 130. For example, the user may take a photo of the item 140 using the device 130 and then proceed to upload the photo to the receiving module 210. As another example, the user may type in a description of the item using the device 130 and then proceed to submit the description to the receiving module 210. In various example embodiments, the receiving module 210 is configured to receive an indication to refrain from transmitting the listing. The indication may be received from the device 130 operated by the user 132.

In various example embodiments, the generation module 220 is configured to generate a geofence surrounding the item location included in the listing. The geofence generated by the generation module 220 may enclose a geographical area around the item location included in the listing received at the receiving module 210. For instance, the geographical area around the item location may be a circular area around the item location. In various example embodiments, the receiving module 210 is further configured to receive a request to modify the generated geofence surrounding the item location. The request may be received from the device 130 operated by the user 132. In response to the received request at the receiving module 210, the generation module 220 is further configured to modify the geofence surrounding the item location. For instance, the generation module 220 may increase the size of the geographical area enclosed by the geofence. Alternatively, the generation module 220 may decrease the size of the geographical area enclosed by the geofence. In various example embodiments, the request received at the receiving module 210 from the device 130 operated by the user 132 may include information that is usable to modify the generated geofence (e.g., location coordinates, click and drag information, or any suitable combination thereof). The generation module 220 may modify the geofence surrounding the item location based on the received information. For example, the device 130 may present an interface that allows the user to modify the dimensions of the geofence by providing location coordinates or by clicking and dragging on the geofence.

In various example embodiments, the generation module 220 is further configured to generate an exchange location within a predetermined distance from the location of the user 132 and within the predetermined distance from the user 152 located within the geographical area enclosed by the geofence, the geofence surrounding the item location. In various example embodiments, the generation module 220 is configured to generate the exchange location based on a location of the user 132, a location of the user 152, and a location of the item 140. For instance, the generated exchange location may be removed from at least a threshold distance from the location of the item 140 but still may be reasonably accessible from both the location of the user 132 and the location of the user 152. The exchange location may be used to facilitate a transaction between the user 132 and the user 152. For instance, if a buyer 132 is selling an item and a seller (e.g., user 152) has indicated interest in the item, then an exchange location may be used to allow both parties to meet and conduct the transaction. Both the location of the use 132 and the user 152 may be detected by the detection module 230, as further explained below. In various example embodiments, the generation module 220 may generate the exchange location based on a selection of preferences received at the receiving module 210 from a device 130, 150 operated by a user 132, 152. The selection of preferences may include distance of the exchange location from a current location (e.g., location of the device 130, 150), a type of exchange location, or any suitable combination thereof. The types of exchange location may include a library, a museum, an office building, or any suitable combination thereof. In various example embodiments, the generation module 220 may generate a plurality of exchange locations. The plurality of exchange locations may be generated based on the selection of preferences received at the receiving module 210. Moreover, the receiving module 210 may be further configured to receive a selection of an exchange location among the generated plurality of exchange locations.

In various example embodiments, the detection module 230 is configured to monitor the generated geofence surrounding the item location. The detection module 230 may also be configured to monitor the modified geofence surrounding the item location. Moreover, the detection module 230 may be further configured to detect a user 152 located within the geographical area enclosed by the geofence around the item location. The user 152 may be a potential buyer. The detection module 230 may be further configured to receive a signal indicating the location of the user 152 as being within the geographical area, the signal generated by the device 150 operated by the user 152. The signal indicating the location of the user 152 as being within the geographical area may include: location coordinates within the geographical area, an address within the geographical area, an association with a structure located within the geographical area, or any suitable combination thereof. For example, the signal indicating the location of the user 152 may include the user 152 performing a “check-in” via the device of the user 152. The “check-in” may be further associated with a location within the geographical area, such as a structure located within the geographical area. In various example embodiments, the detection module 230 is further configured to detect a location of the user 132 from the device 130 operated by the user. For instance, the device operated by the user may include a GPS receiver that may be operable to determine a location of the device 130. Once determined, the location of the device may be sent to the detection module 230. The detection module 230 may use the location information to detect the location of the user 132.

In various example embodiments, the determination module 240 is configured to determine whether the user 152 has performed an action to indicate an interest in the item described in the listing. The performed action may include the user 152 previously conducting a search for the item described in the listing, previously browsing the item described in the listing on a web page, adding a similar item to a wish list, posting a message related to a similar item on a social network site, leaving feedback on the item described in the listing, or any suitable combination thereof. In various example embodiments, the determination module 240 is further configured to access preferences of the user 152 stored in a user profile. The user profile may be retrieved from a profile database. Moreover, the preferences of the user 152 may include preferences for a specific brand of item, a specific type of item, a specific color of an item, or any suitable combination thereof. In various example embodiments, the determination module 240 is further configured to identify a match between an attribute of the item described in the listing and an attribute included in the preferences of the user 152. For instance, the user 152 may indicate a preference for blue jeans, and the item described in the listing may also be for blue jeans. The determination module 240 may also be further configured to determine whether the user 152 has performed the action to indicate an interest in the item described in the listing based at least in part on the identified match. In various example embodiments, the determination module 240 is further configured to receive a request from the user 152 to view the listing. The request may be received from the device 150 of the user 152.

In various example embodiments, the presentation module 250 is configured to transmit the listing to a device 150 operated by user 152. The presentation module 250 may transmit the listing in order to notify the user 152 of the listing. Moreover, the presentation module 250 may transmit the listing in response to the determination module 240 determining that the user 152 has performed the action to indicate an interest in the item. The presentation module 250 may also be further configured to transmit the listing to the device 150 operated by the user 152 in response to the determination module 240 receiving the request to view the listing. In various example embodiments, the presentation module 250 may be further configured to transmit the listing to the device 150 operated by the user 152 based on the preferences of the user 152 stored in the user profile that is accessed by the determination module 240. In various example embodiments, the presentation module 250 is further configured to present the exchanged location to the device 130 operated by the user 132. The presentation module 250 may present the exchange location in response to the exchange location being generated by the generation module 220. The exchange location may be presented to both devices 130 and 150 in order to facilitate a transaction between both users 132 and 152. The presentation module 250 may further configured to transmit an exchange location based on the selection of the exchange location received at the receiving module 210. In other words, the exchange location that has been selected by the user is transmitted to the user. Moreover, the presentation module 250 may prevent the item location from being presented to the device 152 operated by the user 152. For instance, a seller may wish to conceal the item location from the buyer and not have to advertise the precise item location. If the item is being held at the seller's home, the seller may wish to keep the exact location of the item private. Moreover, the buyer may provide preferences on where to meet the seller. As a result, the generated exchange location may be used to facilitate a transaction between the seller and the buyer. In various example embodiments, the presentation module 250 may be further configured to prevent transmitting the listing to the device 150 operated by the user 152 based on the received indication to refrain from transmitting the item listing.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

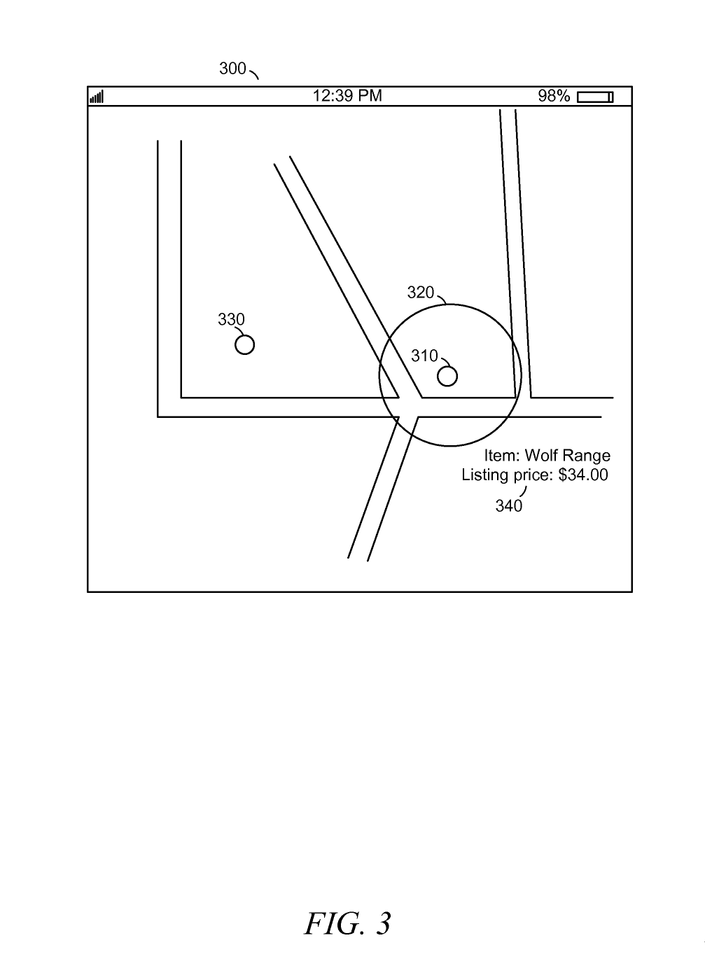

FIG. 3 is an example user interface of a map 300 depicting an item location 310 and geofence 320 surrounding the item location, according to some example embodiments. The geofence 320 surrounding the item location 310 may enclose a geographical area around the item location 310. As depicted in FIG. 3, the geographical area enclosed by the geofence 320 may be a circular area. The receiving module 210 may receive the item location 310 from the device 130 operated by a user 132. The example user interface of the map 300 may be viewed by the user 132 and displayed on the device 130 operated by the user. Moreover, a location 330 of the user 152 may be displayed on the map 300. The detection module 230 is configured to monitor the geofence 320 to detect that the location 330 of the user 152 is within the geographical area enclosed by the geofence 320. In various example embodiments, a description of the item 340 may also be displayed on the map 300.

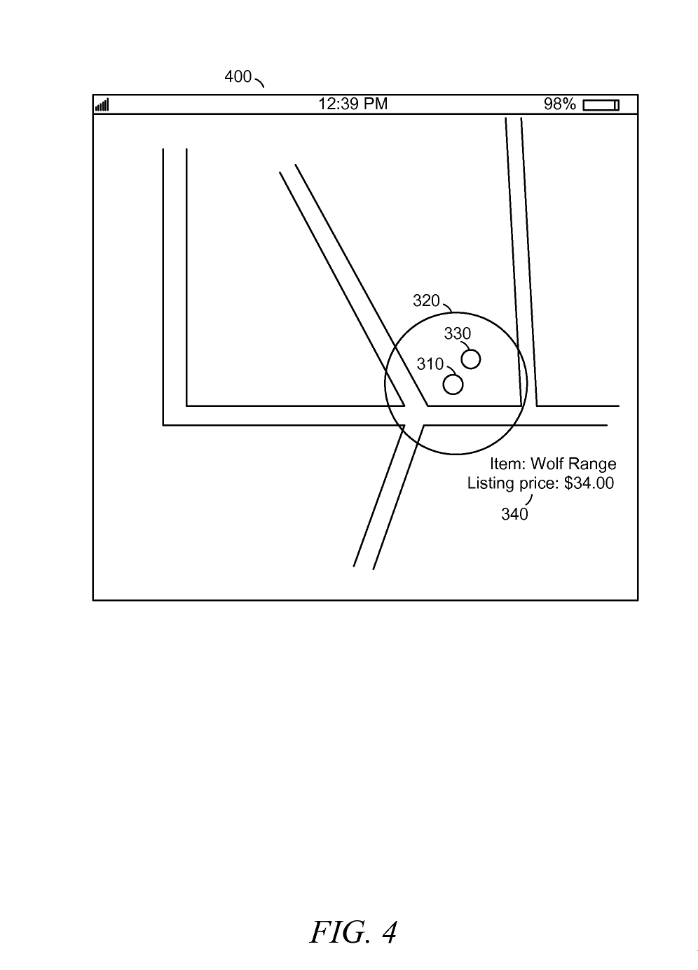

FIG. 4 is an example user interface of a map 400 depicting the item location 310 and the geofence 320 surrounding the item location, according to some example embodiments. The item location 310 and the geofence 320 are in the same position as they were depicted in FIG. 3. However, the location 330 of the user 152 is now depicted as being within the geographical area enclosed by the geofence 320. The detection module 230 may detect that the location 330 of the user 152 is within the geographical area enclosed by the geofence 320. Moreover, the example user interface of the map 400 may be displayed on the device 130 operated by the user 132.

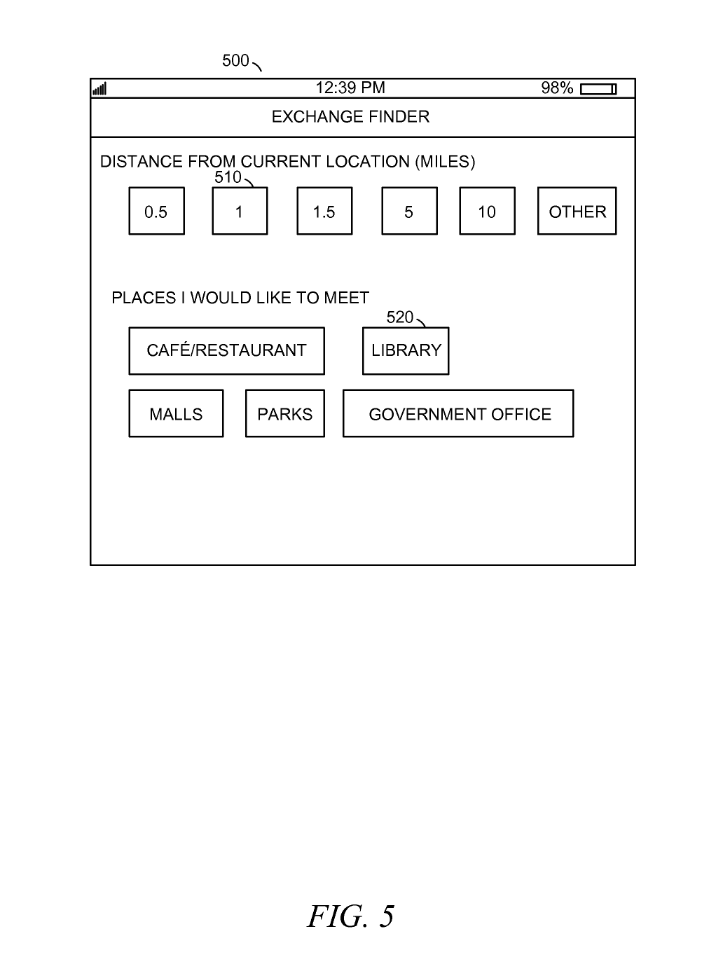

FIG. 5 is an example user interface depicting an exchange finder 500, according to some example embodiments. The exchange finder 500 may be used to indicate a selection of preferences from the device 130 operated by the user. The exchange finder 500 may be displayed in the device 130 of the user 132. The exchange finder 500 may display options for the user to choose from. For instance, the exchange finder 500 may allow the user to select a distance from the current location (e.g. location of the user 132). For example, as an option 510 to choose a location 1 mile from the current location is displayed in FIG. 5. The exchange finder 500 may also allow the user to select a type of location to meet. For example, as an option 520 to choose a library is displayed in FIG. 5. The generation module 220 may be further configured to use the options selected by the user to generate the exchange location. As such, the generation module 220 may generate the exchange location based on the selection of preferences indicated in the user interface. In various example embodiments, the generation module 220 is configured to generate the exchange location based on a location of the user 132, a location of the user 152, and a location of the item 140. For instance, the generated exchange location may be removed from at least a threshold distance from the location of the item 140 but still may be reasonably accessible from both the location of the user 132 and the location of the user 152. Moreover, item attributes of the item 140 may also be used in generating the exchange location. For instance, a coffee shop may not be able to accommodate a grand piano as an exchange location between a buyer and a seller. Whereas a warehouse or a garage may be more suitable for the grand piano. Moreover, location of nearby ATMs may also influence the generation of the exchange location. As such, availability of cash may be factor used by the generation module 220 in generating the exchange location.

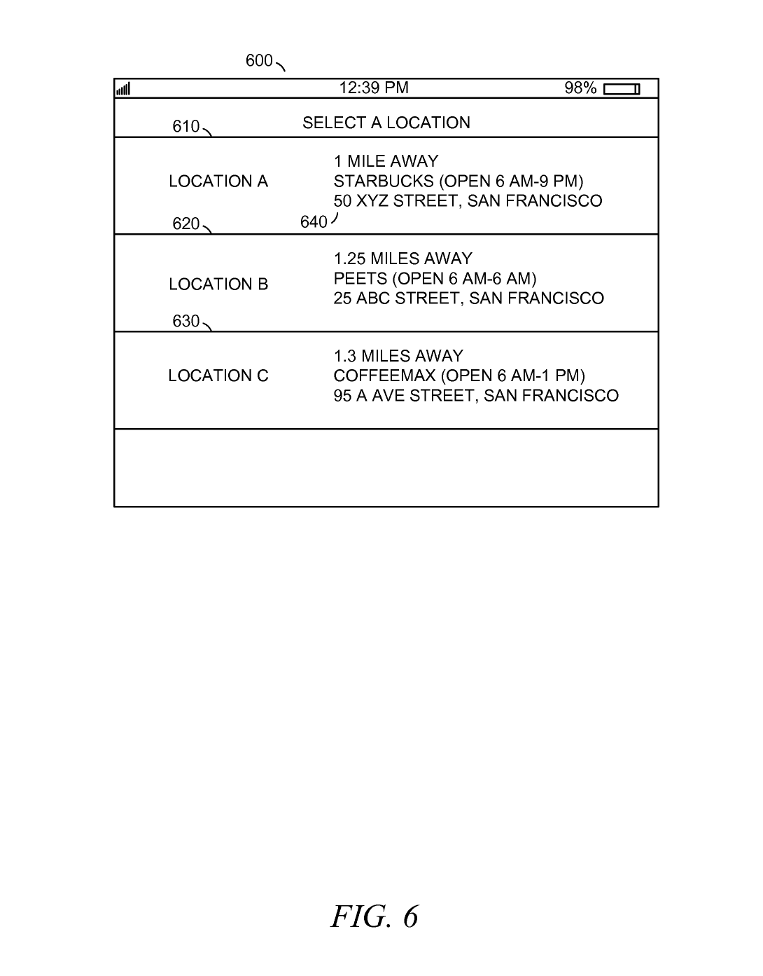

FIG. 6 is an example user interface depicting a set of locations 600, according to some example embodiments. The set of locations may each be an exchange location generated by the generation module 220. For instance, a first location 610 may be displayed as part of the set of locations. Moreover, information 640 regarding first location 610 may also be displayed. In various example embodiments, the information 640 may include an address, a distance from a current location (e.g., location of the user 132), and hours of operation. A second location 620 and a third location 630 may also be displayed as part of the set of locations in the example user interface. The set of locations 600 may be displayed in a device 130 operated by a user 132.

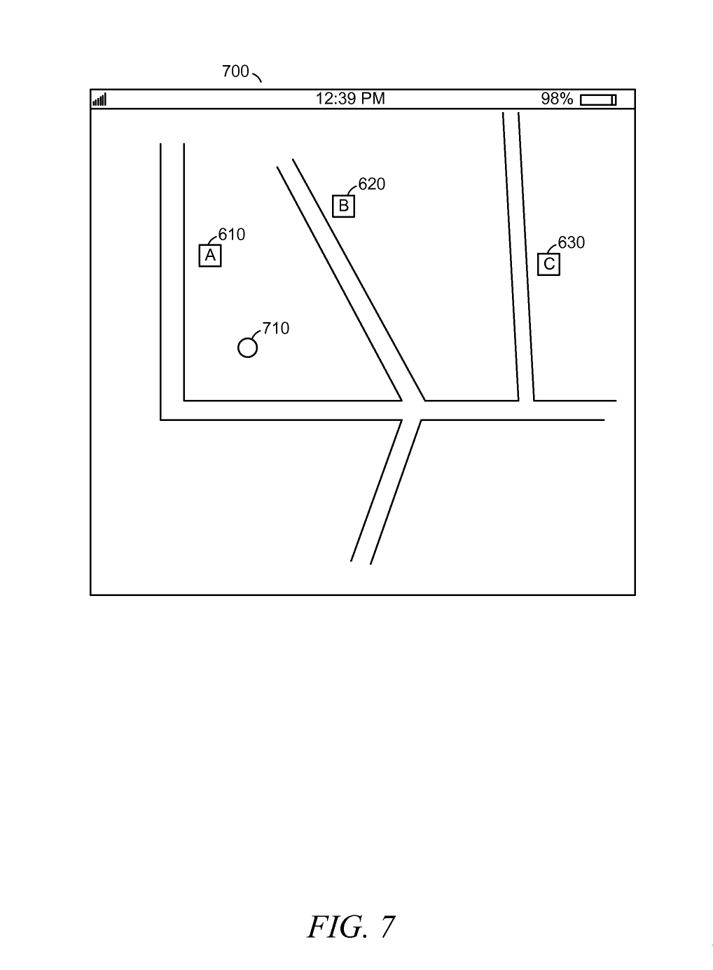

FIG. 7 is an example user interface depicting the set of locations on a map 700, according to some example embodiments. The set of locations displayed in FIG. 6 may also be displayed in the map 700. For instance, the first location 610 displayed in the map 700 corresponds to the first location 610 of FIG. 6. The second location 620 displayed in the map 700 corresponds to the first location 620 of FIG. 6. Lastly, the third location 630 displayed in the map 700 corresponds to the first location 630 of FIG. 6. Moreover, icon 710 displayed on the map 700 may correspond to the location of the user 132. The map 700 may be displayed in the device 130 operated by the user 132.

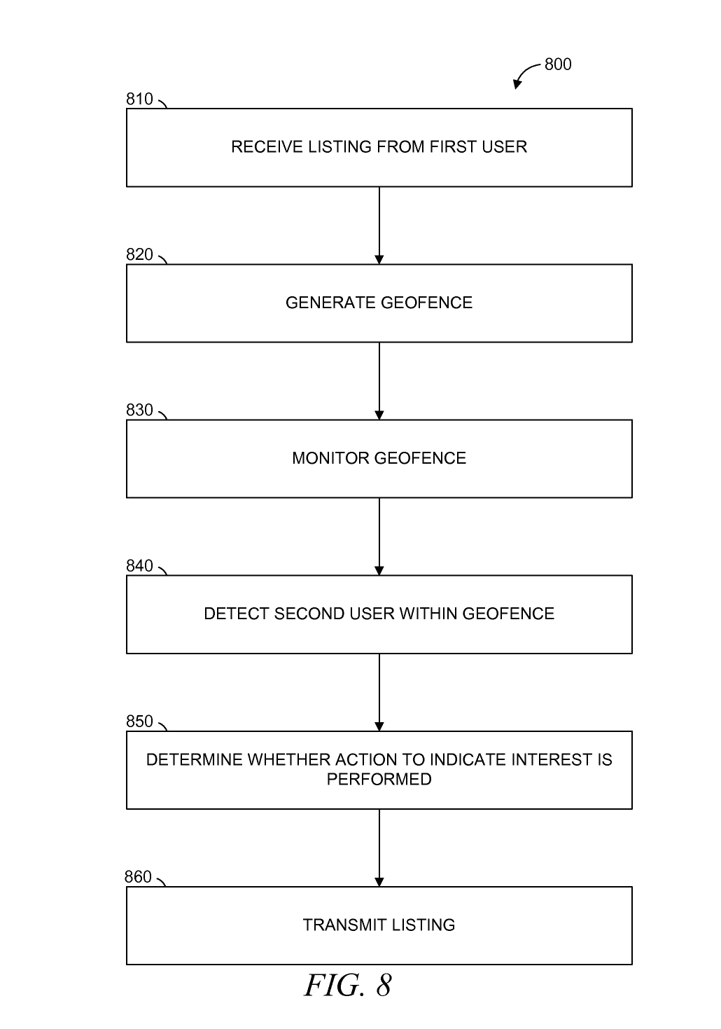

FIG. 8 is a flowchart illustrating a method 800 of transmitting a listing, according to some example embodiments. In an example, the method 800 can include operations such as: receiving a listing at 810, generating a geofence at 820, monitoring the geofence at 830, detecting a user within the geofence at 840, determining interest at 850, and transmitting a listing at 860. The method can begin at operation 810, with the receiving module 210 receiving a listing that is to be published by the presentation module 250. The listing may describe an item and may further include an item location corresponding to the item described in the listing.

At operation 820, the method 800 continues with the generation module 220 generating a geofence surrounding the item location included in the listing. The geofence generated by the generation module 220 encloses a geographical area around the item location included in the listing received at the receiving module 210 at operation 810.

At operation 830, the detection module 230 monitors the generated geofence surrounding the item location.

At operation 840, the method 800 continues with the detection module 230 detecting that the user 152 is located within the geographical area enclosed by the geofence around the item location. The detection module 230 may be further configured to receive a signal indicating the location of the user 152 as being within the geographical area, the signal generated by the device operated by the user 152.

At operation 850, the determination module 240 determines whether the user 152 has performed an action to indicate an interest in the item described in the listing. The performed action may include the user 152 previously conducting a search for the item described in the listing, previously browsing the item described in the listing on a web page, or any suitable combination thereof. In various example embodiments, the determination module 240 is further configured to access preferences of the user 152 stored in a user profile. The user profile may be retrieved from a profile database. Moreover, the preferences of the user 152 may be include preferences for a specific brand of item, a specific type of item, a specific color of an item, or any suitable combination thereof. In various example embodiments, the determination module 240 is further configured to identify a match between an attribute of the item described in the listing and an attribute included in the preferences of the user 152. The determination module 240 may also be further configured to determine whether the user 152 has performed the action to indicate an interest in the item described in the listing based at least in part on the identified match.

At operation 860, the method 800 continues with the presentation module 250 transmitting the listing to a second device operated by the user 152. The presentation module 250 may transmit the listing in order to notify the user 152 of the listing. Moreover, the presentation module 250 may transmit the listing in response to the determination module 240 determining that the user 152 has performed the action to indicate an interest in the item.

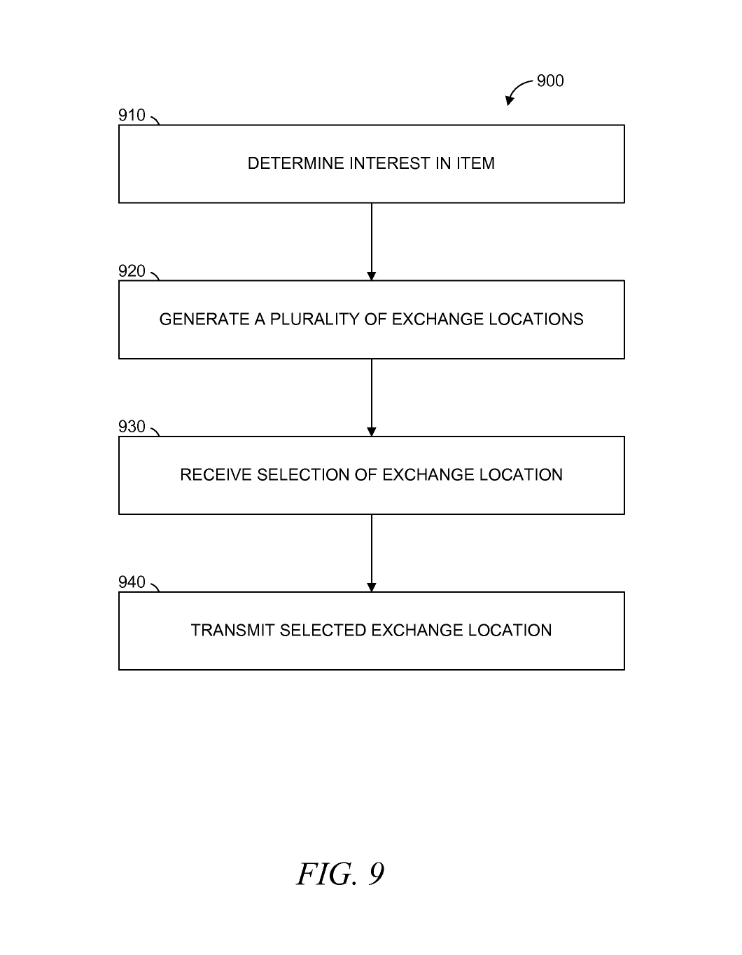

FIG. 9 is a flowchart illustrating a method 900 of transmitting an exchange location, according to some example embodiments. In an example, the method 900 can include operations such as: determining an indication of interest in the item 910, generating a plurality of exchange locations at 920, receiving a selection of an exchange location at 930, and transmitting the selected exchange location at 940.

At operation 910, the method 900 begins with the determination module 240 determining whether a user (e.g., buyer) has performed an action to indicate an interest in the item described in the listing.

At operation 920, the method 900 continues with the generation module 220 generating a plurality exchange locations. The plurality exchange locations may be generated based on a selection of preferences made by the user (e.g., buyer). The selection of preferences may be received at the receiving module 210 from a device operated by the user.

At operation 930, the method 900 continues with the receiving module 210 receiving a selection of an exchange location among the plurality of exchange locations generated by the generation module 220.

At operation 940, the presentation module 250 transmits the exchange location based on the selection of the exchange location received at the receiving module 210.

FIG. 10 is a block diagram illustrating components of a machine 1000, according to some example embodiments, able to read instructions 1024 from a machine-readable medium 1022 (e.g., a machine-readable storage medium, a computer-readable storage medium, or any suitable combination thereof) and perform any one or more of the methodologies discussed herein, in whole or in part. Specifically, FIG. 10 shows the machine 1000 in the example form of a computer system within which the instructions 1024 (e.g., software, a program, an application, an applet, an app, or other executable code) for causing the machine 1000 to perform any one or more of the methodologies discussed herein may be executed, in whole or in part. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, on a central server using one or more processors from a device operated by a first user, a listing for publication by the central server, the listing including an item location corresponding to an item described in the listing;
generating, using the one or more processors, a geofence surrounding the item location, the geofence enclosing a geographical area around the item location;
monitoring, using the one or more processors, the geofence surrounding the item location;
detecting, based on the monitoring of the geofence, a second user located within the geographical area enclosed by the geofence associated with the item location;
determining, using the one or more processors, whether the second user has performed an action to indicate an interest in the item described in the listing; and
transmitting, in response to determining that the second user has performed the action to indicate the interest in the item, the listing to a second device operated by the second user to notify the second user of the listing.

2. The method of claim 1, wherein the determining whether the second user has performed the action to indicate the interest in the item described in the listing includes:
accessing preferences of the second user stored in a user profile, and wherein the transmitting the listing to the second device operated by the second user is based on the accessed preferences of the second user.

3. The method of claim 2, further comprising:
identifying a match between an attribute of the item described in the listing and an attribute included in the preferences of the second user, and wherein the determining whether the second has performed an action to indicate an interest in the item described in the listing is based at least in part on the identified match.

4. The method of claim 1, further comprising:
detecting a location of the first user from the device operated by the first user;
generating an exchange location within a predetermined distance from the location of the first user and within the predetermined distance from the second user located within the geographical area enclosed by the geofence associated with the item location; and
presenting the exchange location to the device of the first user in response to the generating the exchange location.

5. The method of claim 4, further comprising:
preventing the item location from being presented to the second device operated by the second user.

6. The method of claim 1, wherein the detecting the second user located within the geographical area includes receiving a signal indicating the location of the second user as being within the geographical area, the signal generated by the second device operated by the second user.

7. The method of claim 6, wherein the signal indicating the location of the second user as being within the geographical area includes at least one of: location coordinates within the geographical area, an address within the geographical area, and an association with a structure located within the geographical area.

8. The method of claim 1, wherein the determining whether the second user has performed the action to indicate the interest in the item described in the listing includes:
receiving a request from the second user to view the listing, the request received from the second device operated by the second user, and wherein the transmitting the listing to the second device operated by the second user is further in response to the request to view the listing.

9. The method of claim 1, further comprising:
receiving a request to modify the generated geofence surrounding the item location, the request received from the device operated by the first user;
modifying the geofence surrounding the item location in response to the received request, and wherein monitoring the geofence includes monitoring the modified geofence surrounding the item location.

10. The method of claim 1, further comprising:
receiving an indication to refrain from transmitting the listing, and wherein the transmitting the listing to the second device operated by the second user is prevented based on the received indication to refrain from transmitting the listing.

11. A system comprising:
a receiving module configured to receive, on a central server using one or more processors from a device operated by a first user, a listing for publication by the central server, the listing including an item location corresponding to an item described in the listing;
a generation module configured to generate, using the one or more processors, a geofence surrounding the item location, the geofence enclosing a geographical area around the item location;
a detection module configured to:
monitor, using the one or more processors, the geofence surrounding the item location; and
detect, based on the monitoring of the geofence, a second user located within the geographical area enclosed by the geofence associated with the item location;
a determination module configured to determining, using the one or more processors, whether the second user has performed an action to indicate an interest in the item described in the listing; and
a presentation module configured to transmit, in response to determining that the second user has performed the action to indicate the interest in the item, the listing to a second device operated by the second user to notify the second user of the listing.

12. The system of claim 11, wherein the determination module is further configured to access preferences of the second user stored in a user profile, and wherein the presentation module is further configured to transmit the listing to the second device operated by the second user based on the accessed preferences of the second user.

13. The system of claim 12, wherein the determination module is further configured to:
identify a match between an attribute of the item described in the listing and an attribute included in the preferences of the second user; and
determine whether the second user has performed an action to indicate an interest in the item described in the listing based at least in part on the identified match.

14. The system of claim 11, wherein the detection module is further configured to detect a location of the first user from the device operated by the first user, and wherein the generation module is further configured to generate an exchange location within a predetermined distance from the location of the first user and within the predetermined distance from the second user located within the geographical area enclosed by the geofence associated with the item location, and wherein the presentation module is further configured to present the exchange location to the device of the first user in response to the generating the exchange location.

15. The system of claim 14, wherein the presentation module is further configured to prevent the item location from being presented to the second device operated by the second user.

16. The system of claim 11, wherein the detection module is further configured to receive a signal indicating the location of a second user as being within the geographical area, the signal generated by the second device operated by the second user.

17. The system of claim 16, wherein the signal indicating the location of the second user as being within the geographical area includes at least one of: location coordinates within the geographical area, an address within the geographical area, and an association with a structure located within the geographical area.

18. The system of claim 1, wherein the determination module is further configured to receive a request from the second user to view the listing, the request received from the second device operated by the second user, and wherein the presentation module is further configured to transmit the listing to the second device operated by the second user in response to the request to view the listing.

19. The system of claim 1, wherein the receiving module is further configured to receive a request to modify the generated geofence surrounding the item location, the request received from the device operated by the first user, and wherein the generating module is further configured to modify the geofence surrounding the item location in response to the received request, and wherein the detection module is further configured to monitor the modified geofence surrounding the item location.

20. A non-transitory machine-readable medium storing instructions that, when executed by one or more processors of a machine, cause the machine to perform operations comprising:
receiving, on a central server from a device operated by a first user, a listing for publication by the central server, the listing including an item location corresponding to an item described in the listing;
generating a geofence surrounding the item location, the geofence enclosing a geographical area around the item location;
monitoring the geofence surrounding the item location;
detecting, based on the monitoring of the geofence, a second user located within the geographical area enclosed by the geofence associated with the item location;
determining whether the second user has performed an action to indicate an interest in the item described in the listing; and
transmitting, in response to determining that the second user has performed the action to indicate the interest in the item, the listing to a second device operated by the second user to notify the second user of the listing.
